(19) United States
(12) Patent Application Publication
(10) Pub. No.: US 2018/0226088 A1
(43) Pub. Date: Aug. 9, 2018

(54) SYSTEM FOR ANALYZING EMOTION OF SOUND AND METHOD OF THE SAME

(71) Applicant: G&C INTERACTIVE CO., LTD., Seoul (KR)

(72) Inventor: Sun-Kyu HWANG, Goyang-si (KR)

(73) Assignee: G&C INTERACTIVE CO., LTD., Seoul (KR)

(21) Appl. No.: 15/312,668

(22) PCT Filed: Feb. 4, 2016
(86) PCT No.: PCT/KR2016/001253

§ 371 Date: Nov. 21, 2016

(30) Foreign Application Priority Data
Jan. 29, 2016 (KR) 10-2016-0011805

(51) Int. Cl. G10L 25/63; G10L 25/90

(52) U.S. Cl. CPC G10L 25/63; G10L 25/90

(57) ABSTRACT

A system for analyzing an emotion of a sound includes: an input unit to which target sound data is input; a basic element extraction unit extracting a basic element from the target sound data to generate target basic element information; a chord progression extraction unit extracting a chord progression from the target sound data to generate target chord progression information; and an emotion determining unit calculating a target emotion value by applying the target basic element information and the target chord progression information to an emotion extraction model generated by using sample sound data.

### TECHNICAL FIELD

The present invention relates to a system for analyzing an emotion of a sound and a method of the same. More particularly, the present invention relates to a system for analyzing an emotion of a sound and a method of the same using the system, the system extracting and analyzing basic elements of a sound, such as pitch, tempo, duration of the pitch, and chord progressions of the sound, so as to extract precise emotion information for the sound, thereby providing or enabling the use of various services based on the extracted information.

### BACKGROUND ART

Generally, music is played in a concert hall, on a TV or a radio, and from various storage devices such as a cassette tape. However, due to developments in network environment and services using the internet, recently, services such as real-time streaming and music-on-demand (MOD) have been provided with the conventional method of playing music. In recent years, streaming and MOD services have become widely used.

Especially, compared with the past, large amounts of various kinds of music are available. Therefore, interest has been focused on a method of searching for music that a user wants and enabling the music to be played.

However, a conventional music service cannot meet customer needs. Particularly, recommendation based on user tastes and similar styles is inaccurate, and the recommendation is limited to a singer, an album, and a popular song. Basically, an analysis system is required to provide a music service. However, since only using the system analyzing and recommending music based on limited information such as classification of music, a singer, and a composer, and information unrelated to content of music, improvement in such a system is required

### DISCLOSURE

### Technical Problem

The present invention has been proposed to solve the problems in the related art. The present invention is thus intended to propose a system for analyzing an emotion of a sound and a method of the same using the system, the system extracting and analyzing basic elements of a sound, such as pitch, tempo, duration of the pitch, and chord progressions of the sound, so as to extract precise emotion information for the sound, thereby providing or enabling the use of various services based on the extracted information.

### Technical Solution

In order to achieve the above object, according to one aspect of the present invention, there is provided a system for analyzing an emotion of a sound, the system including: an input unit to which target sound data is input from outside; a basic element extraction unit extracting a basic element from the target sound data to generate target basic element information; a chord progression extraction unit extracting a chord progression from the target sound data to generate target chord progression information; and an emotion determining unit calculating a target emotion value by applying the target basic element information and the target chord progression information to an emotion extraction model generated by using sample sound data.

The system may include: a sample data base storing the sample sound data; and an analyzing unit generating the emotion extraction model by performing regression analysis on sample chord progression information extracted from the sample sound data and on a sample emotion value of the sample sound data.

The target emotion value or the sample emotion value may be a value numerically expressing levels of arousal and valence of the sample sound data.

The sample emotion value may be generated by judges who have listened to the sample sound data that is predetermined.

The basic element may include at least one of pitch, duration of the pitch, and tempo of the target sound data.

The target chord progression information may be a chord progression combination of a current chord and a subsequent chord, and may be information about same chord progression combinations in the target sound data or about a number of the same chord progression combinations

The analyzing unit may generate the emotion extraction model again in a case of adding or changing the sample sound data.

According to another aspect, there is provided a method of analyzing an emotion of a sound, the method including: inputting target sound data that is subjected to an analysis to an input unit; extracting, by a basic element extraction unit, a basic element from the target sound data to generate target basic element information; extracting, by a chord progression extraction unit, a chord progression from the target sound data to generate target chord progression information; and calculating, by an emotion determining unit, a target emotion value by applying the target basic element information and the target chord progression information to an emotion extraction model generated in advance.

The method may include: storing, at a sample sound data storing step, at least one selected piece of the sample sound data in a sample data base; calculating, at a sample information calculating step, a sample emotion value, sample basic element information, and sample chord progression information of the sample sound data; and generating, by an analyzing unit at a model generating step, the emotion extraction model by analyzing the sample emotion value, the sample basic element information, and the sample chord progression information.

The target emotion value or the sample emotion value may be a value numerically expressing levels of arousal and valence of the sample sound data.

The sample emotion value may be generated by judges who have listened to the sample sound data that is predetermined.

The basic element may include at least one of pitch, duration of the pitch, and tempo of the target sound data.

The target chord progression information may be a chord progression combination of a current chord and a subsequent chord, and may be information about same chord progression combinations in the target sound data or about a number of the same chord progression combinations

At least one of the sample sound data storing step, the sample information calculating step, and the model generating step may be performed again in a case of changing or adding the sample sound data or the sample emotion value.

### Advantageous Effects

According to the system for analyzing an emotion of a sound and the method of the same using the system, it is possible to extract and analyze the basic elements of a sound, such as pitch, tempo, duration of the pitch, and chord progressions of the sound, so as to extract precise emotion information for the sound, thereby providing or enabling the use of various services based on the extracted information.

### DESCRIPTION OF DRAWINGS

FIG. 1 is an exemplary view showing an example of configurations of a system for analyzing an emotion of a sound according to the present invention.

FIG. 2 is an exemplary view for explaining a chord progression extraction.

FIG. 3 is an exemplary view for explaining an emotion value.

FIG. 4 is a flowchart for explaining a method of analyzing an emotion of a sound according to the present invention.

### MODE FOR INVENTION

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention unclear. In the drawings, certain features presented in the drawings are expanded, reduced, or simplified for easy explanation, and the drawings and the constituent elements may not be appropriately illustrated. However, those of ordinary skill in the art could easily understand such detailed matters.

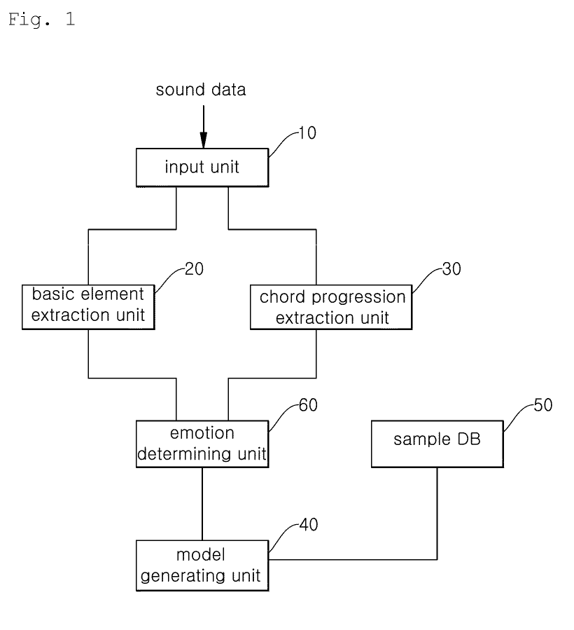

FIG. 1 is an exemplary view showing an example of configurations of a system for analyzing an emotion of a sound according to the present invention.

Referring to FIG. 1, a system for analyzing an emotion of a sound includes an input unit 10; a basic element extraction unit 20; a chord progression extraction unit 30; a model generating unit 40 functioning as an analyzing unit; a sample database 50; and an emotion determining unit 60.

Target sound data, which is subjected to an analysis, is input to the input unit 10. The target sound data inputted to the input unit 10 is provided to the basic element extraction unit 20 and the chord progression extraction unit 30. The input unit 10 may convert the target sound data in various formats into data in a format that can be processed at the basic element extraction unit 20 and the chord progression extraction unit 30. The input unit may provide the converted target sound data to the basic element extraction unit and the chord progression extraction unit. In addition, in order to input target sound data to the input unit 10, the input unit is provided with an interface which may be connected to terminal devices. Alternatively, the input unit may be provided as a device that can access a network, whereby the input unit may receive target sound data from a sound data providing system. Here, the target sound data is data having a format that can be outputted by a particular device. Particularly, the target sound data inputted to the input unit 10 may be symbolic sound data provided in MIDI format. The symbolic sound data is sound data recorded by digitalizing information of sheet music that is actually used.

The basic element extraction unit 20 analyzes the target sound data to extract basic elements from the target sound data for emotion analysis. Specifically, the basic element extraction unit 20 extracts pitch, duration of the pitch, and tempo from the target sound data, and generates target basic element information based on the extraction. The basic elements extracted by the basic element extraction unit 20 are extracted by a preset method such as the number of each pitch and the number of each of durations of the pitch in the target sound data. The basic elements are converted into data. Here, when target sound data is not symbolic sound data, basic elements are extracted by a predetermined analysis tool.

The chord progression extraction unit 30 extracts a chord progression from the target sound data. Specifically, the target sound data includes harmony that is one of main elements of music, namely, a plurality of chords. The chord progression extraction unit 30 extracts chord progressions from the target sound data to generate target chord progression information. Music is formed by the chord progressions, and the chord progression extraction unit 30 extracts the chord progressions that are the relations between current chords and subsequent chords. For example, when chord progressions such as ‘C-G/B-C/G-F-C/E’ are recorded in the target sound data, relations between current chords-subsequent chords are extracted like ‘C-G/B’, ‘G/B-C/G’, ‘C/G-F’, ‘F-C/E’. Next, the number of each of the chord progressions in the target sound data is analyzed, and target chord progression information is generated based on the analyzed result.

The emotion determining unit 60 calculates a target emotion value by using both the target basic element information extracted by the basic element extraction unit 20 and the target chord progression information extracted by the chord progression extraction unit 30. To this end, the emotion determining unit 60 uses sample sound data and an emotion extraction model to calculate the target emotion value. Specifically, the emotion determining unit 60 applies both the basic elements such as pitch, duration of the pitch, tempo extracted from the target sound data by the basic element extraction unit 20 and the target chord progression information extracted by the chord progression extraction unit 30 to the emotion extraction model, and calculates the target emotion value based on the applied result.

Specifically, the emotion extraction model is generated by performing a regression analysis or support vector regression (SVR) analysis on a sample basic element and sample chord progression information that are obtained from an abundance of sample sound data, and on a sample emotion value generated by evaluating the sample sound data by users. The emotion extraction model is a value that is a standardized relationship of sample emotion values based on both the basic elements of the sample sound data and the chord progressions of the sample sound data and is provided in a graph form or an expression form by using the sample basic element, the sample chord progression information, and the sample emotion value. When inputting the basic elements of the target sound data and the chord progressions of the target sound data to the emotion extraction model, a target emotion value is extracted by applying the basic elements and the chord progressions to the emotion extraction model. To this end, the model generating unit 40 of FIG. 1 is provided.

The sample database 50 stores sample data used for generating the emotion extraction model. The sample data stored in the sample database 50 includes sample sound data, a sample emotion value, sample basic element information, and sample chord progression information. Specifically, the sample sound data is an abundance of sound data selected for generating the emotion extraction model. The sample emotion value is data in a numerical value of a sample emotion value generated by judges who have listened to the sample sound data. In addition, the sample basis element information is data of basic elements extracted from the sample sound data. The sample chord progression information is data of sample chord progression information extracted from the sample sound data. Here, a target emotion value or a sample emotion value may be expressed as Arousal-Valence (AV) value. The AV value may be a value of a combination of levels of arousal and positive/negative valence. For example, in case of a sad ballad, the sad ballad may be indicated as low level of arousal and relatively high level of negative valence. Levels of arousal and negative valence may vary depending on levels of sadness. The AV value is a value numerically expressing levels of arousal and positive/negative valence. When the AV value is used as a sample emotion value, the AV value may be used as it is, without being limited thereto.

The model generating unit 40 generates an emotion extraction model by using the sample sound data stored in the sample database 50. Specifically, the model generating unit generates the emotion extraction model by performing the regression analysis or the SVR analysis on the sample basic element, the sample chord progression information, and the sample emotion value that are obtained from the sample sound data. The emotion extraction model is a value that is calculated by using relationships of sample emotion values based on both the basic elements of the sample sound data and the sample chord progression information provided and is provided in a graph form or an expression form. Usually, a user may understand the emotion extraction model in the graph form, and the expression form is used in internal process, without being limited thereto. When inputting the target basic element information and the target chord progression information of the target sound data to the emotion extraction model, a position or result value of the target sound data is calculated by using the expression or the graph of the emotion extraction model. The position or result value may be understood as a target emotion value of the target sound data. The model generating unit 40 generates and provides the emotion extraction model to the emotion determining unit 60 so as to perform the analysis on the target sound data. Particularly, a new emotion extraction model may be generated in case of adding or changing sample sound data.

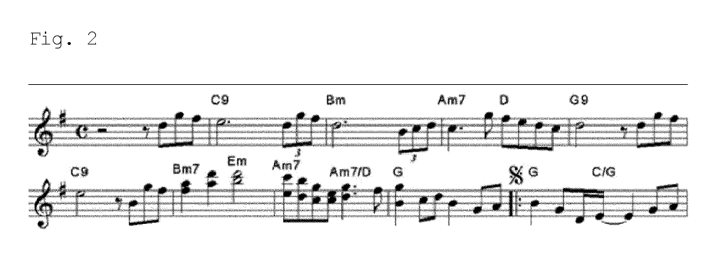

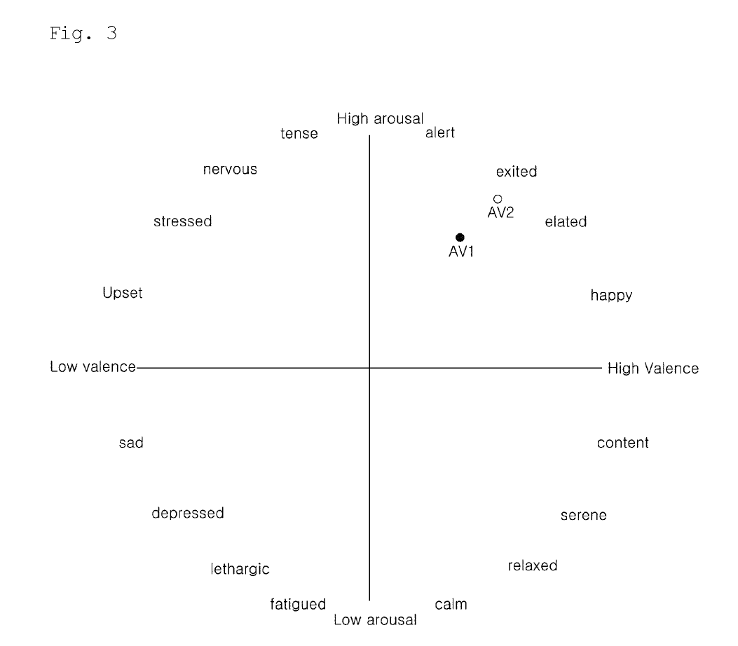

FIGS. 2 and 3 are exemplary views for explaining process of analysis and extraction of emotion information. FIG. 2 is an exemplary view for explaining a chord progression extraction. FIG. 3 is an exemplary view for explaining an emotion value.

Referring to FIG. 2, generally, in sheet music, chords indicating flow of harmony during playing music are printed at an upper end of the staff. The flow of harmony is one of main elements affecting the mood of music, for example, flow of feeling such as sadness, cheerfulness, liveliness, solemnity, loneliness. Therefore, the precise emotion information is generated for target sound data by analyzing the flow of feeling.

To this end, the chord progression extraction unit 30 extracts chord progressions from the target sound data. As described above, the target chord progression information is generated by calculating combinations of current chords and subsequent chords in the target sound data and the number of the same combinations. Here, the subsequent chord is a current chord of a subsequent combination.

That is, when chord progressions are ‘C-G/B-Am⁷’, combinations of current chords and subsequent chords are respectively ‘C-G/B’ and ‘G/B-Am⁷’. The number of each of combinations is calculated by analyzing how many times each of the combinations is included in the target sound data. The number of each of combinations is generated as the target chord progression information.

The mood of music is affected depending on the ratio of the combinations in target sound data. The ratio is used to generate an emotion extraction model, and to calculate the target emotion value, thereby generating the precise emotion information of music. For example, when using a conventional music classification method, music having a fast tempo is mostly classified as lively and cheerful music. However, according to the present invention, sad music may be detected depending on chord progressions thereof. Even though the sad music has a fast tempo, the mood of the sad music may be defined and classified as ‘sadness’.

In the meantime, as shown in FIG. 3, the target emotion value is an important indicator indicating mood of music. By using the target emotion value, it is possible to precisely analyze moods of favorite music of a user, whereby various and precise services may be provided to the user. To this end, it is required to precisely calculate the target emotion value of target sound data.

The target emotion value may be defined as the AV value. The AV value is a combination of levels of arousal and positive/negative valence such that the AV value indicates mood of music. That is, cheerful and lively music has high level of arousal and positive valence, while gloomy music with a fast tempo has high level of arousal and negative valence.

Referring to FIG. 3, target emotion values may be classified in detail into 20 ranges. By using the classification, as shown in FIG. 3, the target emotion value of the target sound data may be calculated. Here, numerically, level of arousal is a value of A2, and level of valence is a value of V1. In the case of an example of the target sound data, the example of the target sound data may be interpreted as slightly exciting and slightly cheerful music.

When a target emotion value of target sound data is AV2, the target sound data may be interpreted as lively and cheerful music, but the target sound data has relatively high level of arousal in comparison with target sound data having AV1. Therefore, mood of the target sound data having AV2 is different from the target sound data having AV1.

The emotion extraction model using chord progressions as analysis elements is generated by precisely calculating the sample emotion value. In comparison with a conventional music classification method, it is possible to precisely classify mood of music by applying chord progressions and basic elements of target sound data to the emotion extraction model. Therefore, it is possible to provide various services such as a music recommendation service.

The target emotion value of the target sound data is precisely calculated by using chord progressions of the target sound data, whereby it is possible to provide various services.

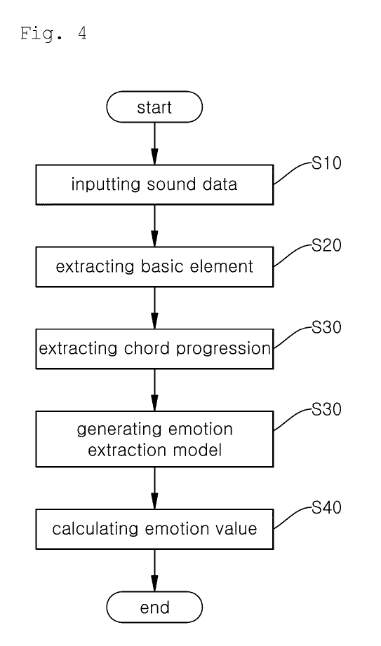

Referring to FIG. 4, a method of analyzing an emotion of a sound includes: inputting target sound data at step S10; extracting a basis element at step S20; extracting a chord progression at step S30; generating an emotion extraction model at step S40; and calculating a target emotion value at step S50.

The inputting of the target sound data at step S10 is a step of inputting target sound data to the input unit 10. The target sound data is subjected to an analysis of an external system or an external apparatus. Here, the inputted target sound data may be symbolic sound data in which information of the sheet music is recorded as described above, without being limited thereto. At the inputting of the target sound data at step S10, the input unit 10 may convert the target sound data provided in various formats into data provided in a format the enables the target sound data to be easily analyzed.

The extracting of a basis element at step S20 is a step of extracting pitch, duration of the pitch, and tempo that are basic elements of music from the target sound data received from the input unit 10, and of generating the target basic element information based on the extracted basic elements. At the extracting of a basis element at step S20, the basic element extraction unit may extract the number of each pitch, and kinds of and the number of each of durations of the pitch in the target sound data, without being limited thereto.

The extracting of a chord progression at step S30 is a step whereby the chord progression extraction unit 30 extracts combinations of chord progressions and the number of same combinations from the target sound data received from the input unit 10, thereby generating the target chord progression information. At the extracting of a chord progression at step S30, the chord progression extraction unit 30 generates the target chord progression information by separating the combinations of the current chords and the subsequent chords to calculate the number of the same combinations.

The generating of an emotion extraction model at step S40 is a step whereby the analyzing unit 40 generates the emotion extraction model by applying the above-described steps to the sample sound data stored in the sample database 50. At the generating of an emotion extraction model at step S40, the emotion extraction model is generated by performing analysis such as the regression analysis on sample basic element information, sample chord progression information of the sample sound data, and on the sample emotion value generated by judges for the sample sound data. The generating of an emotion extraction model at step S40 may be performed once at an initial operation of the system for analyzing an emotion of a sound. Alternatively, the step S40 may be performed again in a case of adding or changing the sample sound data, without being limited thereto.

The calculating of a target emotion value at step S50 is a step whereby the emotion determining unit calculates a target emotion value by applying the target basic element information and the target chord progression information of the target sound data, which are generated through steps S10 to S30, to the emotion extraction model of step S40.

While the exemplary embodiments of the invention have been described above, the embodiments are only examples of the invention, and it will be understood by those skilled in the art that the invention can be modified in various forms without departing from the technical spirit of the invention. Therefore, the scope of the invention should be determined on the basis of the descriptions in the appended claims, not any specific embodiment, and all equivalents thereof should belong to the scope of the invention.

### INDUSTRIAL APPLICABILITY

According to the system for analyzing the emotion of the sound and the method of the same, the emotion extraction model using chord progressions as an analysis element is generated. In comparison with a conventional music classification method, it is possible to precisely classify the mood of sound data by applying chord progressions and basic elements of sound data to the emotion extraction model. Consequently, it is possible to provide various services such as music recommendation service.

1. A system for analyzing an emotion of a sound, the system comprising:
an input unit to which target sound data is input from outside;
a basic element extraction unit extracting a basic element from the target sound data to generate target basic element information;
a chord progression extraction unit extracting a chord progression from the target sound data to generate target chord progression information; and
an emotion determining unit calculating a target emotion value by applying the target basic element information and the target chord progression information to an emotion extraction model generated by using sample sound data.

2. The system of claim 1, further comprising:
a sample data base storing the sample sound data; and
an analyzing unit generating the emotion extraction model by performing regression analysis on sample chord progression information extracted from the sample sound data and on a sample emotion value of the sample sound data.

3. The system of claim 2, wherein the target emotion value or the sample emotion value is a value numerically expressing levels of arousal and valence of the sample sound data.

4. The system of claim 3, wherein the sample emotion value is generated by judges who have listened to the sample sound data that is predetermined.

5. The system of claim 1, wherein the basic element comprises at least one of pitch, duration of the pitch, and tempo of the target sound data.

6. The system of claim 1, wherein the target chord progression information is a chord progression combination of a current chord and a subsequent chord, and is information about same chord progression combinations in the target sound data or about a number of the same chord progression combinations

7. The system of claim 2, wherein the analyzing unit generates the emotion extraction model again in a case of adding or changing the sample sound data.

8. A method of analyzing an emotion of a sound, the method comprising:
inputting target sound data that is subjected to analysis to an input unit;
extracting, by a basic element extraction unit, a basic element from the target sound data to generate target basic element information;
extracting, by a chord progression extraction unit, a chord progression from the target sound data to generate target chord progression information; and
calculating, by an emotion determining unit, a target emotion value by applying the target basic element information and the target chord progression information to an emotion extraction model generated in advance.

9. The method of claim 8, further comprising:
storing, at a sample sound data storing step, at least one selected piece of sample sound data in a sample data base ;
calculating, at a sample information calculating step, a sample emotion value, sample basic element information, and sample chord progression information of the sample sound data; and
generating, by an analyzing unit at a model generating step, the emotion extraction model by analyzing the sample emotion value, the sample basic element information, and the sample chord progression information.

10. The method of claim 9, wherein the target emotion value or the sample emotion value is a value numerically expressing levels of arousal and valence of the sample sound data.

11. The method of claim 10, wherein the sample emotion value is generated by judges who have listened to the sample sound data that is predetermined.

12. The method of claim 8, wherein the basic element comprises at least one of pitch, duration of the pitch, and tempo of the target sound data.

13. The method of claim 8, wherein the target chord progression information is a chord progression combination of a current chord and a subsequent chord, and is information about same chord progression combinations in the target sound data or about a number of the same chord progression combinations

14. The method of claim 9, wherein at least one of the sample sound data storing step, the sample information calculating step, and the model generating step is performed again in a case of changing or adding the sample sound data or the sample emotion value.
